(19) United States
(12) Patent Application Publication
(10) Pub. No.: US 2020/0163488 A1
(43) Pub. Date: May 28, 2020

(54) VOICE-COMMAND CONTROLLED HEATABLE CONTAINER

(71) Applicant: John C. Fontana, Hilton Head, SC (US)

(72) Inventor: John C. Fontana, Hilton Head, SC (US)

(21) Appl. No.: 16/199,895

(22) Filed: Nov. 26, 2018

(51) Int. Cl. A47J 36/24; H05B 6/06

(52) U.S. Cl. CPC A47J 36/2472; A47G 19/2288; H05B 6/06

(57) ABSTRACT

The present application is directed to an apparatus that includes an inner vessel, a vacuum insulator vessel disposed around and bonded to the inner vessel, a bottom cover affixed to the inner vessel and the vacuum insulator, the bottom cover including a control circuit with a voice recognition module, a transistor switch and one or more sensors. A heater strip is disposed around at least a portion of the bottom cover and is in contact with the inner vessel, a charging interface is configured to receive a power charge from an external source, a battery pack with a number of conduits is configured to provide a power supply to the control circuit and the heater strip and to receive the power charge from the charging interface, and the voice recognition module is configured to identify audio commands received and activate the power supply of the battery pack to the heater strip to increase a temperature of the inner vessel and contents of the inner vessel.

### I. RELATED APPLICATIONS

There are no previously filed, nor currently any co-pending applications, anywhere in the world.

### II. FIELD OF INVENTION

The present application relates to a container that houses a self-contained heating element and more particularly, a container that has a voice control feature so a user can activate the heating element to heat the container and its contents on command.

### III. BACKGROUND OF THE INVENTION

Conventionally, a container with thermal properties may passively keep liquid or other contents stored within hot or warm. The reality is that such containers may not be capable of maintaining a certain temperature range and certainly not indefinitely, as the thermal properties of such containers are only mildly effective at keeping the heat from escaping into the surrounding environment and causing the contents to become room temperature.

### IV. SUMMARY OF THE INVENTION

Example embodiments of the present application include an apparatus that includes an inner vessel, a vacuum insulator vessel disposed around and bonded to the inner vessel, a bottom cover affixed to the inner vessel and the vacuum insulator, the bottom cover including a control circuit with a voice recognition module, a transistor switch and one or more sensors. A heater strip is disposed around at least a portion of the bottom cover and is in contact with the inner vessel, a charging interface is configured to receive a power charge from an external source, a battery pack with a number of conduits is configured to provide a power supply to the control circuit and the heater strip and to receive the power charge from the charging interface, and the voice recognition module is configured to identify audio commands received and activate the power supply of the battery pack to the heater strip to increase a temperature of the inner vessel and contents of the inner vessel.

### V. BRIEF DESCRIPTION OF THE DRAWING(S)

FIG. 1A illustrates an exploded view of the container configuration, in accordance with example embodiments.

FIG. 1B illustrates at top view of the container configuration, in accordance with example embodiments.

FIG. 1C illustrates a side view of the container configuration, in accordance with example embodiments.

FIG. 1D illustrates a hollow side view of the container configuration, in accordance with example embodiments.

FIG. 1E illustrates a view of the contents inside the bottom cover, in accordance with example embodiments.

FIG. 1F illustrates a top view and side view of the bottom cover, in accordance with example embodiments.

FIG. 1G illustrates a top view and side view of the heater strip, in accordance with example embodiments.

FIG. 1H illustrates a side view of the inner vessel with the heating strip affixed to a circumferential surface area of a lower portion of the inner vessel, in accordance with example embodiments.

FIG. 2 illustrates a schematic view of the contents of the circuits included in the bottom cover, in accordance with example embodiments.

### VI. DETAILED DESCRIPTION OF THE EMBODIMENT(S)

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

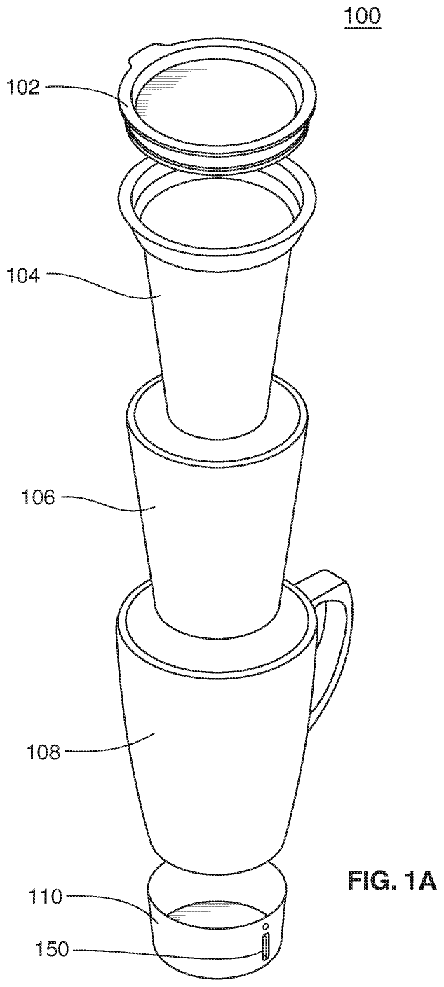

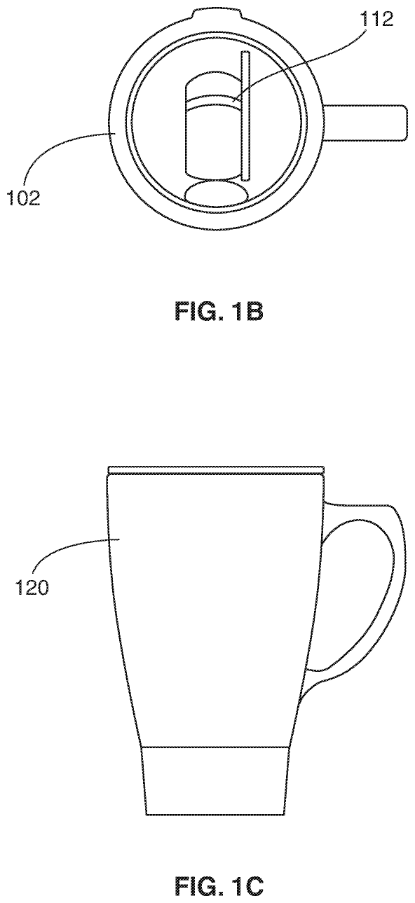

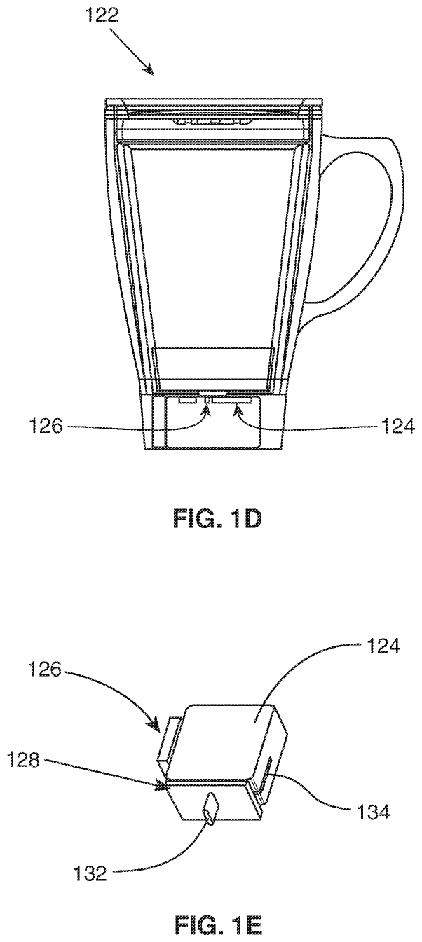

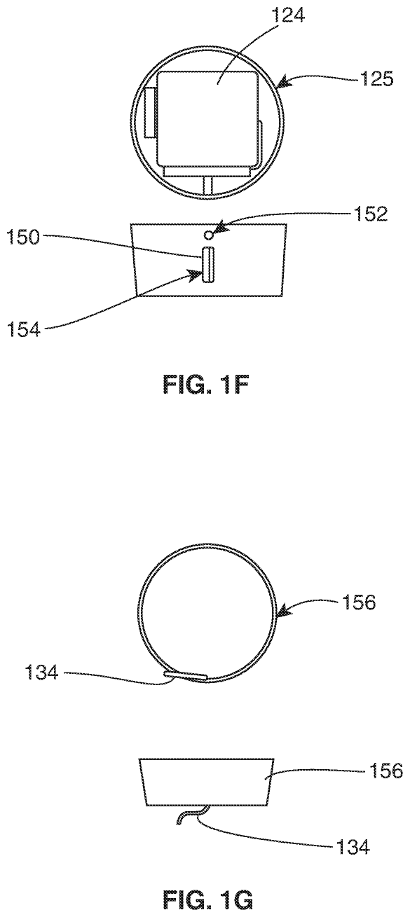

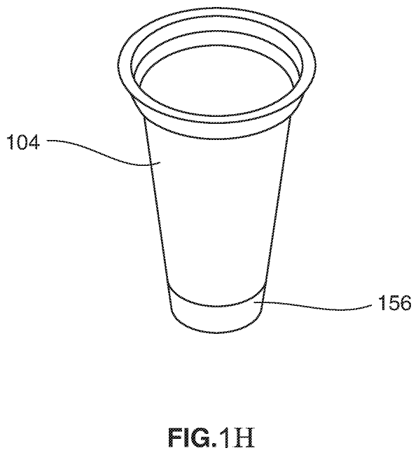

FIG. 1A illustrates an exploded view of the container configuration, in accordance with example embodiments. Referring to FIG. 1A, the configuration 100 includes a bottom cover 110 with circuitry, a battery, a conduit, a charging interface (i.e., USB interface), a circuit with a microphone to receive voice commands, and other components described in detail in other figures. The ceramic outer shell 108 has an aesthetic appearance similar to a coffee mug, with a handle, the vacuum insulator vessel 106 provides a barrier to protect the components of the bottom cover from fluids, the inner vessel 104 is hollow and constructed of a stainless steel material or other liquid-safe material having a continuous bottom edge to which a heating element 156 is bonded, the heating element 156 warms contents of the inner vessel 104 (e.g., water, coffee, tea, etc.). The plastic lid 102 has a slidable mouth piece to secure the liquids from leaking during transport, the lid 102 may also have an O-ring to seal the lid securely to the inner vessel 104. The inner vessel 104 is permanently bonded to the ceramic outer shell 108 with an adhesive bond. The vacuum insulator vessel 106 may restrict the heat from transferring from the inner vessel 104 to the ceramic outer shell 108. The bottom cover 110 is bonded to the ceramic outer shell 108. The bottom cover 110 may also include a USB interface portal 150 extending perpendicularly through the longitudinal sidewall of cover 110.

FIG. 1B illustrates a top view of the container configuration, in accordance with example embodiments. Referring to FIG. 1B, the plastic lid 102 includes a mouth piece cover 112 that is slidably adjustable over the liquid exit portion where a user would place their mouth to drink from the container.

FIG. 1C illustrates a side view of the container configuration, in accordance with example embodiments. Referring to FIG. 1C, the assembled cup 120 is shown as appearing as a regular coffee mug style of container.

FIG. 1D illustrates a hollow side view of the container configuration, in accordance with example embodiments. Referring to FIG. 1D, the hollow-view 122 includes a standard cup with various layers and a battery pack 124 and control module 126 along with other circuitry at the bottom portion which include a charging interface, optional LED to indicate charging status, ON/OFF status, etc., a battery pack, and conduit disposed from the battery to the heater strip in the surrounding area of the bottom cover.

FIG. 1E illustrates a view of the contents inside the bottom cover, in accordance with example embodiments. Referring to FIG. 1E, the contents of the bottom cover, aside from the heating element/strip 156 disposed around the bottom cover and extending upward into the body of the lower container portion, the bottom cover houses a battery pack 124, which is charged by a battery charging interface 132 that connects to the battery via an electrical power conduit 134, a control module, a faceplate 128 which holds the USB charging interface 132, and one or more optional LEDs and a microphone (not shown), in position on the outer container body of the bottom cover.

FIG. 1F illustrates a top view and side view of the bottom cover 110, in accordance with example embodiments. Referring to FIG. 1F, the battery pack 124 is set into the bottom cover as shown in the top view 125. The side view includes a USB interface 154 oriented flush to an inner peripheral lip of the interface portal 150. The interface portal 150 provides direct and open passage to the USB interface 154. The portal 150 is depicted generally as having an oval shape; however, other portal shapes, sizes, and configurations are envisioned for accommodating a vast number of other battery charging interfaces, USB interfaces and similar interfaces via which power and/or audio and video signals may be transmitted. Further illustrated in the side view is an optional LED 152, or set of LEDs, which may light up when charging and/or applying heat to the contents of the container to prompt a user of the device status. Also, if a user engages the voice recognition feature by commanding the heat to turn on via speaking a command (e.g., “heat up”, “turn on”, “turn off”, etc.), then the LED may indicate that command was executed and the battery has engaged the heater strip 156.

FIG. 1G illustrates a top view and side view of the heater strip, in accordance with example embodiments. Referring to FIG. 1G, the electric power conduit 134 is a wire that extends from the control module 134 to the battery pack 124, and then another set of wires extend to a contact surface of the heater strip 156, so the power may be applied via electron flow to the heater strip which causes a temperature of the heater strip and, in turn, the liquids inside the container to rise. Another conduit may be used from the USB interface to the battery pack to charge the battery pack 124 when necessary via a USB plug to an external power source. Another conduit may be used to provide power from the battery pack to the circuit 200.

FIG. 1H illustrates a side view of the inner vessel with the heating strip affixed to a circumferential surface area of a lower portion of the inner vessel, in accordance with example embodiments. Referring to FIG. 1H, the heater strip 156 may extend around the vessel layer 104 in a semi-cylindrical or full-cylindrical manner. The material may be a metal conductive layer, which may be flexible to bond to the surface of the inner vessel. The material may also have an adhesive to bond the strip to the outer surface of the inner vessel. The heat may transfer directly through the conductive material of the inner vessel to heat the liquid contents.

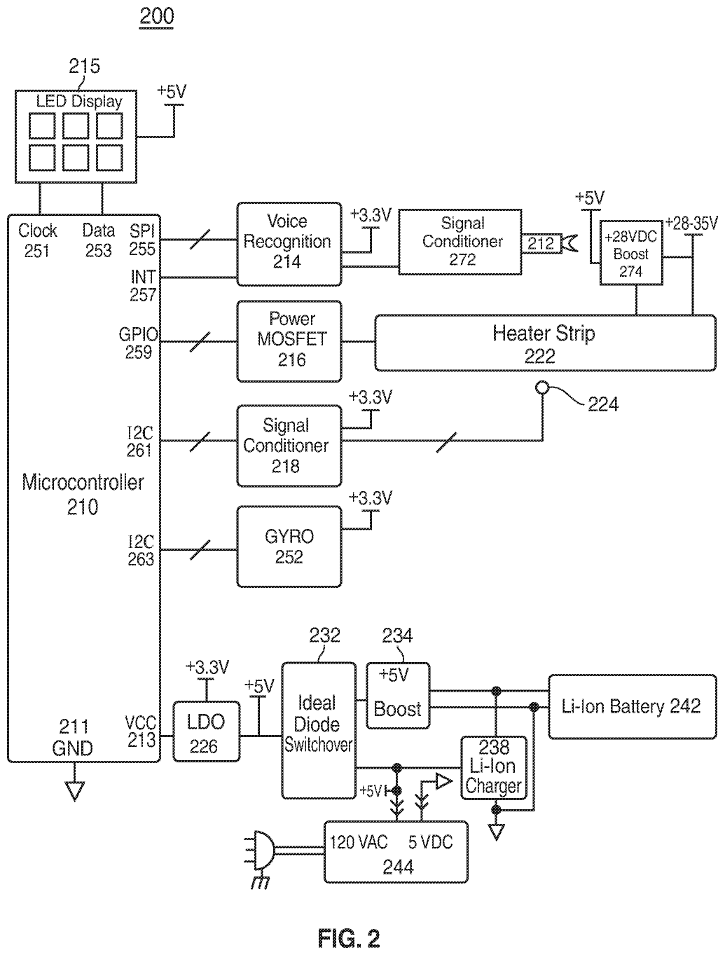

FIG. 2 illustrates a schematic view of the contents of the circuits included in the bottom cover, in accordance with example embodiments. The circuit 200 may be entirely housed inside the control module 126 as an integrated circuit with various sensors, and circuit elements. The circuit may operate with a battery, such as a lithium-ion polymer battery 242 coupled to a charger 238, a +5V boost component 234, a voltage transformer interface 244, an ideal diode switchover 232, a +5V input interface and a +3.3V low-drop-out voltage regulator (LDO) 226, which has a Vcc interface 213 to the microcontroller 210, coupled to a ground GND 211. The microcontroller 210 controls the operation of the circuit by managing a voice recognition module 214, via a serial peripheral interface (SPI) 255 interface and a standard interface (INT) 257 programmed to respond to commands from a microphone 212. The microcontroller 210 also controls a metal oxide semiconductor field effect transistor (MOSFET) 216, via a general purpose input/output (GPIO) interface 259, to apply/revoke a charge to the heater strip 222 when commands are received and identified to begin the heating process and/or stop the heating process. A signal conditioner module 218 may provide a signal, via an I-squared-C (I2C) interface 261 to stop applying heat in the event that the temperature of the heater strip 222 exceeds a temperature threshold measured by a sensor 224 in contact with the heater strip 222. A gyroscope 252 is also in communication with the microcontroller 210 via an I2C interface 263. The gyroscope provides a control function to limit/provide control features when motion, movement and/or orientation are changed via the user moving the container, dropping the container, etc. In general, the movement could limit the power applied to the heater strip, so the cup does not continue to heat. The voice recognition unit 214 is connected to a signal conditioner unit 272, which is coupled to a microphone 212. The heater strip may have a 28 VDC boost component 274 which provides a voltage boost to cause the heater strip 222 to heat-up. The LED display 213 may have a clock 251 and data interface 253, and may be a digital LED display panel with multiple word or number display possibilities, such as to inform the user whether the heat is on or off, what the temperature is, etc.

In operation, the heating element/strip 222 should not be engaged when the cup is empty, the battery operator heater does not rely on external power and cords while in operation. The container will heat fluids based on the fluid level to maintain a proper temperature without overheating or underheating. Ideally, the amount of heat (e.g., time) applied is based on a beverage level within the container. Spills, tip-over of the container, low levels of fluid should trigger the heating to turn off automatically if engaged. In one example, the heater strip may be disposed near a middle section of the container in direct contact with the inner vessel 104 so the heat can be applied directly to the liquids.

In one example embodiment, a voice command control feature may be applied to control the temperature of the liquids in the container. For example, a command may be spoken aloud (e.g., “hot”, “hotter”, “hottest”, “warm”, “lukewarm”, etc.) to heat to a certain temperature level, a hotter level, a hottest level, etc. The heater feature is based on the heater strip 156 being heated by an electric charge applied by the battery pack 124. The battery may be a lithium-polymer battery pack located in a bottom chamber of the container. The activation of the heat is applied by the microcontroller 210 also located in the bottom chamber/cover 110 of the container 100. In one example, a gyroscope sensor included on the circuit may sense movement of the container, which wakes-up the microcontroller and causes the system to power-on for command reception. The voice command may then be made and identified by the microphone 212 and authenticated by programmed commands stored in the voice recognition module 214. The commands are identified by an audio processor function and the heater strip 156 is controlled by pulse width modulation to the desired temperature which is monitored by the feedback sensory of the signal conditioner 218 and a sensor located in the inner vessel 104. Also, when the gyro component senses the container has tipped to over by a certain degree, the microcontroller 210 may go to an inactive mode after a certain amount of time.

References to the ‘controller’ or ‘controller module’ may indicate all or most of the components in FIG. 2 including the microcontroller 210. Those skilled in the art will appreciate that certain variations of this invention may include certain components not shown and may omit one or more components which are shown in comparable embodiments but with the same general purpose sought by the invention. The microcontroller 210 is based on a 8-bit, low energy, high performance component that runs at 48 MHz with 64 KB of flash memory and 4 KB of RAM with ports necessary to communicate with the sensors and other control modules. Other commands which may be recognized may be temperature specific, such as “heat to 160 degrees”, or another temperature level. A matched command that is recognized by the voice recognition module 214 will cause a change in temperature. The digital microphone 212 is used to detect the audio via omnidirectional sound detection, which is used to detect audio in a low-power mode of operation to conserve battery life. Movement is detected and will wake-up the control functions by the gyro's (252) movement detection capabilities. The gyro 252 or other components based on a 3-axis digital output gyroscope in communication with the controller's interfaces. This movement may cause a power-on function which then enables voice commands to be identified. The LED interface may be a 3-digit LED display 213 that connected to the microcontroller 210, and may indicate “on” and “off” statuses. The heater strip 156/222 may operate at 42 watts with a resistance of 18.5 Ohms. The boosted supply of voltage, such as 28 volts DC is applied to the strip by the MOSFET 216, which may switch on and off to boost a heater supply of voltage from 3.1 to 4.2 VDC of the battery pack to achieve the 42 watts for heating purposes.

Temperature is sensed by a digital sensor 224, which is placed on the inner vessel's body and which is connected by a conduit to the circuit. The battery pack may supply a 5 VDC supply to the boost regulator 234. The battery is charged by a charging station that includes a 5 VDC supply from a micro USB connection or similar power supply interface. The interface may offer power to the circuit board via an ideal diode circuit, otherwise the power can be diverted to the battery.

In other example embodiment, a fluid sensor may be used to identify whether there is sufficient amount of fluid in the container to proceed with a heating operation. In other words, when the fluid drops below a threshold level in the container, the circuit may not be operable to engage the heating strip to heat the fluid as a safety measure. In another example, a pressure switch and actuator may be used to permit a user to press an actuator (button) to initiate a heating operation. This also permits the heater function to turn off after a certain period of time after the actuator is depressed. The accelerometer and/or gyroscope can identify when the container is in motion and may disengage the heat supply during such an event and/or an appreciable time after movement to ensure the container is resting on a secure surface prior to engaging the heat strip 156/222.

One example embodiment may include an apparatus that provides an inner vessel, a vacuum insulator vessel disposed around and bonded to the inner vessel, a bottom cover affixed to the inner vessel and the vacuum insulator, the bottom cover including a control circuit with a voice recognition module, a transistor switch and one or more sensors. The apparatus also includes a heater strip disposed around at least a portion of the bottom cover and in contact with the inner vessel, a charging interface configured to receive a power charge from an external source, a battery pack with a plurality of conduits configured to provide a power supply to the control circuit and the heater strip and to receive the power charge from the charging interface, and where the voice recognition module is configured to identify audio commands received and activate the power supply of the battery pack to the heater strip to increase a temperature of the inner vessel and contents of the inner vessel.

The inner vessel may be metal. The one or more sensors include a gyroscope, a temperature sensor, and a microphone. The gyroscope disables the power supply from heating the heater strip when movement is sensed. The gyroscope enables the power supply to heat the heater strip when no movement is detected for a defined period of time. The temperature sensor enables the power supply to heat the heater strip when a temperature of the inner vessel is below a predetermined temperature threshold and disables the power supply from heating the heater strip when the temperature of the inner vessel is equal to or above the predetermined temperature threshold. The predetermined temperature threshold is set based on an audio command received and processed by the voice recognition module. An outer shell is disposed around and bonded to the vacuum insulator and the bottom cover, the outer shell includes a ceramic or plastic material and a handle. The charging interface is a USB interface. An LED is included on an outer portion of the bottom cover. A face plate is disposed on the outer portion of the bottom cover and is configured to hold the LED and the USB interface.

Although an exemplary embodiment of the system, method, and device of the present invention has been illustrated in the accompanied drawings and described in the foregoing detailed description, it will be understood that the invention is not limited to the embodiments disclosed, but is capable of numerous rearrangements, modifications, and substitutions without departing from the spirit or scope of the invention as set forth and defined by the following claims. For example, the capabilities of the system can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules. Also, the messages sent or received by any of the modules may be sent or received directly and/or via one or more of the other modules.

Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, as electronic signals.

It will be readily understood that the components of the invention, as generally described and illustrated in the figures herein, may be arranged and designed in a wide variety of different configurations. Thus, the detailed description of the embodiments is not intended to limit the scope of the invention as claimed, but is merely representative of selected embodiments of the invention.

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

While preferred embodiments of the present application have been described, it is to be understood that the embodiments described are illustrative only and the scope of the application is to be defined solely by the appended claims when considered with a full range of equivalents and modifications thereto.

1. An apparatus comprising:
an inner vessel;
a vacuum insulator vessel disposed around and bonded to the inner vessel;
a bottom cover affixed to the inner vessel and the vacuum insulator, the bottom cover comprising:
a control circuit comprising a voice recognition module, a transistor switch and one or more sensors;
a heater strip disposed around at least a portion of the bottom cover and in contact with the inner vessel;
a charging interface configured to receive a power charge from an external source;
a battery pack housed in the bottom cover, the battery pack comprises a plurality of conduits configured to provide a power supply to the control circuit and the heater strip and to receive the power charge from the charging interface; and
wherein the voice recognition module identifies audio commands received and activates the power supply of the battery pack to the heater strip to increase a temperature of the inner vessel and contents of the inner vessel.

2. The apparatus of claim 1, wherein the inner vessel is metal.

3. The apparatus of claim 1, wherein the one or more sensors comprise:
a gyroscope, the gyroscope disables the power supply from heating the heater strip when movement is sensed, and wherein the gyroscope enables the power supply to heat the heater strip when no movement is detected for a defined period of time;
a temperature sensor; and
a digital microphone, the digital microphone detects audio omnidirectionally, the omnidirectionally detected audio is identified and received by the voice recognition module.

4. (canceled)

5. (canceled)

6. The apparatus of claim 3, wherein the temperature sensor enables the power supply to heat the heater strip when a temperature of the inner vessel is below a predetermined temperature threshold and disables the power supply from heating the heater strip when the temperature of the inner vessel is equal to or above the predetermined temperature threshold.

7. The apparatus of claim 6, wherein the predetermined temperature threshold is set based on an omnidirectionally detected audio command received and processed by the voice recognition module.

8. The apparatus of claim 1, further comprising:
an outer shell disposed around and bonded to the vacuum insulator and the bottom cover, the outer shell comprising a handle, and wherein the outer shell comprising a ceramic material.

9. The apparatus of claim 1, wherein the charging interface is a USB interface.

10. The apparatus of claim 8, further comprising:
an LED on an outer portion of the bottom cover.

11. The apparatus of claim 10, further comprising:
a face plate disposed on the outer portion of the bottom cover, the face plate holds the LED and the USB interface.

12. The apparatus of claim 1, further comprising:
an outer shell disposed around and bonded to the vacuum insulator and the bottom cover, the outer shell comprising a handle, and wherein the outer shell comprising a plastic material.

13. The apparatus of claim 12, further comprising:
an LED on an outer portion of the bottom cover.

14. The apparatus of claim 13, further comprising:
a face plate disposed on the outer portion of the bottom cover, the face plate holds the LED and the USB interface.
